(19) United States
(12) Patent Application Publication
(10) Pub. No.: US 2006/0184345 A1
(43) Pub. Date: Aug. 17, 2006

(54) Method for producing a complex technical system

(75) Inventors: Ralf Belschner, Pliezhausen (DE); Jascha Freess, Korb (DE); Markus Mrossko, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/207,823

(22) Filed: Aug. 22, 2005

(30) Foreign Application Priority Data
Feb. 12, 2005 (DE) 10 2005 006 428.0

(51) Int. Cl. G06G 7/48

(52) U.S. Cl. 703/8

(57) ABSTRACT

In a method for producing a complex technical system in a vehicle, as a first step, technical component states are defined for each component in the system, and used to produce an overall model in which all the states for all the components are stored. In a further step, an installation space within the vehicle is established for each component and the electronic component parts of the component are established, producing an overall architecture model for the electronic architecture in the vehicle, with each component being allocated specific electrical/electronic component parts, an installation space and component states. The electrical cabling of the electrical parts of the components and their interfaces are additionally established. When a component is relocated to a different installation space in the vehicle or when the range of possible component states of a component is changed, the necessary signal transmitting operations between the components are calculated for the overall architecture model.

### BACKGROUND AND SUMMARY OF THE INVENTION

This application claims the priority of German patent application 10 2005 006 428.0, filed Feb. 12, 2005, the disclosure of which is expressly incorporated by reference herein.

The invention relates to a method for producing a complex technical system in a vehicle, in which the technical component states of each component are first defined, and used to produce an overall model in which all the states for all the components are stored. An installation place within the vehicle is then established for each component, and the electronic component parts of the component are assigned, producing an overall architecture model for the electronic architecture in the vehicle. Each component is allocated specific electrical/electronic parts, their installation space and their component states.

Technical systems in vehicles are frequently developed by many different companies, and later installed in the vehicle at the premises of the vehicle manufacturer. Due to the interlinkage of the individual systems, technical changes to one component usually have a corresponding effect on many other component parts, requiring either a re-initialization or parameterization, or a revised hardware architecture with respect to the other components. Complexity and time requirements have heretofore prompted the introduction of individual software/hardware development systems in which, for example, a list of features is produced on the basis of the required states of a component. This list of features is then used as a basis for producing a flow chart, structogram or compilable software.

Further, hardware development systems make it possible to create or optimize automatically the interlinkage of vehicle components or their wired interconnection in the vehicle, based on the known component structure. Development systems of this type are known as “DOORS”, “XDIS” or “DaVinci”.

With vehicles, however, there is the added problem that not only are components subjected to further technical development, but they are fitted into different installation spaces within the vehicle, which affects the interlinkage and cabling, as well as the software modules activating these components. As a result, the interlinkage has to be adapted in the individual, mutually independent development systems. In addition, the line distribution has to be adapted in a further development system, and then the software and the newly added features or omitted features have to be adapted in the further systems. All the result logs of the individual development systems must then be manually compiled, so that the effort involved is very great, particularly in the case of evaluation of entire systems.

One object of the present invention is to provide an improved method for producing a complex technical system, in which resulting changes in the electronic architecture are automatically developed or calculated when individual components are relocated into new installation spaces.

This and other objects and advantages are achieved by the method according to the invention, in which additional electrical cabling of the electrical parts of the component and their interfaces is provided and when a component is relocated to a different installation site within the vehicle, or when the extent of the component states of a component is changed, the necessary signal transmitting operations between the components are calculated for the overall architecture model.

According to one embodiment of the invention, in the latter situation the electrical cabling of the individual component parts of the component and their interfaces is additionally established; the overall architecture model is displayed on an outline of the vehicle, and the necessary changes to the architectural arrangement of the electronic component parts are calculated or optimized for the overall architecture model.

The method of the present invention comprises a concatenation of individual development systems and is designed so that, when an individual component is relocated, its requirements with respect to installation space, interlinkage, cabling, parameterization, and new software modules are automatically examined. It is a particular challenge to provide the appropriate electrical/electronic (“EE”) architecture within a vehicle during the concept phase of the electrical/electronic architecture. During the entire development phase of the vehicle, this so-called EE architecture undergoes a wide variety of changes, including costs, overall dimensions, weight and quality. The method of the present invention supports the development of the vehicle in the choice of the correct EE architecture, and makes it possible for the various possibilities to be assessed quickly and objectively.

The method according to the invention first describes the EE architecture within the vehicle in all individual components and their mutual electronic dependencies, and uses this information to create an overall architecture model, including modeling of interlinkage topology, component functions and wiring harness connections to the individual components. In a first step, the overall architecture model is checked with regard to complete interlinkage, presence of the necessary power supply lines and the assignment of the individual functions to the specific components.

According to the method, a list of features is produced, breaking down the overall architecture model into individual functional models (such as, for example vehicle-interior activation, vehicle-engine/transmission activation, or vehicle-lighting activation). For each of these functional models, the required features are described (for example light on, light automatically on, light off, parking light, brake light, etc.), and are assigned to the associated EE components. On the basis of the features produced in this way, the associated wiring harness and the associated interlinkage (for example CAN data bus, power supply) is produced for the already defined components, such as a light control device, engine control device, etc. In a further step, for each EE component it is determined which data are required, and from which other component such data are obtained. On the basis of this data relationship, the method for producing a complex technical system automatically calculates the necessary interlinkage and can also determine with respect to the data bus which minimum requirements are necessary for messages on the data bus.

In the method for producing a complex technical system, the overall architecture model is associated with an outline depiction of the vehicle in such a way that each component is assigned exactly to the installation space within the vehicle by displacement on the screen of a computer, using a mouse or other visualizing device. This creates a unique assignment of the components and the associated interlinkage with respect to the overall EE architecture model over the outline of the vehicle. If, in a later development phase, the functionality of a component is then taken over into another component, the method according to the invention automatically calculates the required data for the changed component, based on the addition of the required data from two components; the interlinkage is adapted and the message formats for the newly created component are created by addition from the old message formats.

The method according to the invention is operated on an interlinked computer system in the development area of a vehicle manufacturer and has corresponding editors for presenting the individual steps of the method. Function, communication, interlinkage and component diagrams can be produced. A topology distribution or the vehicle's electrical system can also be presented on this editor, in each case with the required components, features and connections. When there are changes in the overall system, the corresponding diagrams are adapted automatically, so that the resultant requirements can be called up by the individual developer within the interlinked system. In this way, many development engineers can work in a system and, when there is a change in the complex technical system at one point, the changes are immediately implemented in the overall system. Each developer therefore always knows the latest state of the development system.

The method according to the invention further supports the EE architecture process at the vehicle manufacturer premises by permitting specific models or the overall system to be provided at the premises of a subcontracted supplier. Thus, it is possible for only those areas of the overall EE architecture that are of interest to the subcontracted supplier (and the necessary interfaces) to be provided at the premises of said supplier. When there are subsequent changes, the effects on the interface and on the points of the EE architecture which are of concern to the subcontracted supplier can be incorporated in the presentation by a synchronization method.

The method for producing a complex technical system according to the invention may be used for example, for the exterior vehicle lighting. In the overall architecture model, the individual light sources and the associated electronic components and control devices are positioned in the outline of the vehicle. Then, the individual features of the light sources, cabling/interlinkage of the component parts and the interlinkage of the control devices with one another are calculated, and the associated electrical and/or information technology signals are optimized. If a component is then added when there is later a change in the EE architecture (for example an emergency light is added), the necessary signals are generated for each transmission medium of the cabling (in particular, in the data bus, lines and so on) and, for each line, for each data bus, a threshold value for the number of signals to be transmitted or the limits with respect to voltage or current on a line are assigned to this transmission medium. If this change causes an increased transmission of signals or a rising power of the current supplied on the lines, the method automatically calculates the number of messages or current values and compares them with a threshold value assigned to each line. If the threshold value is exceeded, the system will automatically produce a further signal path and send a certain number of messages or signals over the new signal path. Furthermore, in this operation an error message is generated for the developer, so that he can deal with the issues concerned.

The method according to the invention reproduces the technical development process for an EE architecture in the vehicle. In a first phase, the EE architecture is organized in a way which corresponds to the installation spaces, with the geometry of the vehicle being provided or displayed in the form of an outline or some other representation, such as a plan view or an exploded representation. For this purpose, certain data from the vehicle shell (for example, the geometry of the chassis, the installation spaces for the wiring harnesses and free installation spaces in the vehicle) can be taken into account in the method, and the components planned in an optimized way. In a further step, in various components the suppliers are allocated and the systems are treated separately in accordance with the scope of delivery, so that interfaces with respect to the different subsystems can be calculated. In this manner, each supplier or subcontracted supplier can be given only the subsystem necessary for him, for the verification of his own EE architecture.

In a further step in the method, the features of each component and the required functions are assigned for each component in a function editor. In an interlinkage editor, the necessary interlinkage, which is obtained from the functions and features of the components, is automatically built up in a way somewhat similar to an auto router, and then optimized with regard to both the line paths and also the message density. For example, in the case of a data bus, the volume of messages can be taken into account from the outset and, if appropriate, an improved design planned from the beginning.

In a topolology editor, the remaining free installation spaces in the vehicle are assigned to the individual components; accordingly, the corresponding line length of the cabling and of the bus systems can be calculated exactly, because the installation location of the components has been determined.

By means of a circuit diagram editor, in the method according to the invention it is possible to integrate a predefined component into the EE architecture, merely by describing the features, the functions and the interface between the two systems (that is, the existing EE architecture and the newly added component); and line lengths and line weights, costs and a component profile can be produced in the development process. Furthermore, the interfaces can be defined so exactly and subsystems exported in such a way that each subcontracted supplier can be given an assigned EE architecture. In particular when relocating components, the system automatically calculates the necessary cable length to the new installation location and the functions which may no longer be required. Certain descriptions of the EE architecture can be exported from the system for the development. These include description of the vehicle's electrical system, which describes both the data bus interlinkage and the wiring harness. Furthermore, the control device topology and the overall system description belong to the exportable formats.

The method according to the invention may be implemented by software modules in the form of an integrated development platform, and the electronic/electrical architecture can be modeled with the individual components and control devices. The individual components are semantically linked, and interlinkage within the EE architecture is established on the basis of the features and functions of the components. Finally, a description of each individual component can be exported. The integrated development platform has a number of isolated development tools, such as a model-based development environment or a unit for optimizing the interlinkage. One advantage of the method is that, when there is a change of individual components in the overall system, the data are corrected and the system is optimized to the new change.

Other objects, advantages and novel features of the present invention will become apparent from the following detailed description of the invention when considered in conjunction with the accompanying drawings.

### BRIEF DESCRIPTION OF THE DRAWINGS

FIG. 1 is a diagram of known development platforms;

FIG. 2 shows a user interface of the development software according to the invention, for producing a complex technical system;

FIG. 3 is a schematic representation of the steps in the method according to the invention;

FIG. 4 shows an EE architecture developed using the method according to the invention; and

FIG. 5 is a representation of the EE architecture development process to be carried out by the method according to the invention for producing a complex technical system.

### DETAILED DESCRIPTION OF THE DRAWINGS

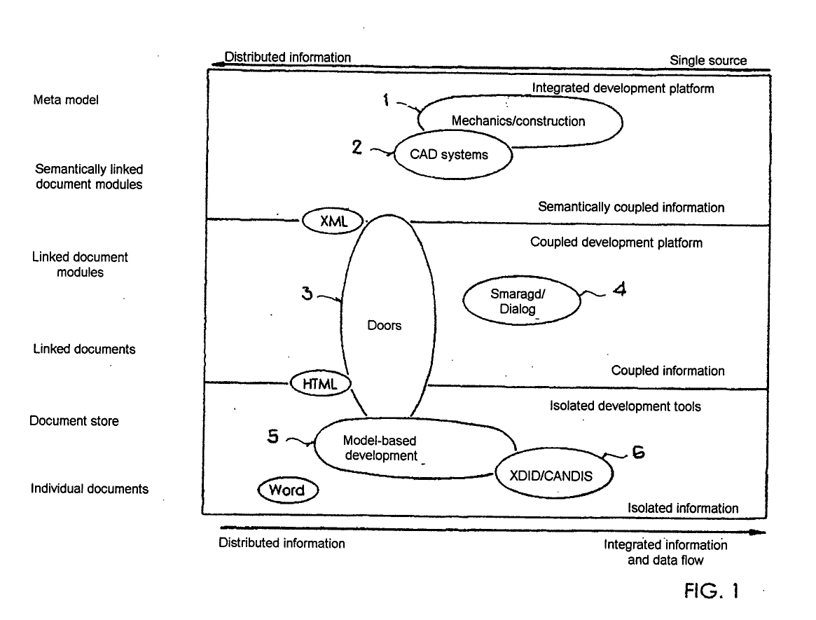

In FIG. 1, various development platforms according to the prior art are broken down according to their information distribution and the development functions. A construction program for the mechanical development 1 and CAD systems 2 may be regarded as the first integrated development platform. The data are in this case entered according to the mechanical requirements for the component to be developed in the CAD system 2 and used to develop the corresponding component. In the CAD system 2, meta models (i.e., views of the component to be developed from various directions and under various conditions), are thereby used as a background. On account of the input by means of semantic information, semantically linked document modules can be created in the mechanical construction and development platform 1 or in the CAD system 2, and then taken into account in the further development. For this purpose, the individual data are exported from the CAD system 2 and, if appropriate, they can be converted and read into a further development platform.

In the prior art, already coupled development platforms are known from various companies under the names “DOORS” 3, “Smaragd” 4 or “Dialog” 4, to name just a few. In this case, modules are developed in separate development environments and the data extracted from them can in each case be further used in the other development environment. Moreover, coupled or linked information can be stored in documents, so that these data (for example dimensions, voltage values or power consumptions, or types of component parts) can be entered for every development environment. The technical descriptive language used for the description is preferably an HTML or an XML descriptive language. By means of these technical languages, specific functions of components and subassemblies can be described and further used in another development environment.

Finally, isolated development tools, so-called model-based development environments 5 (for example, “XDIS” or “CANDIS”) or other development tools are also known from the prior art. Isolated information is stored in the system (for example, in Word) under a specific description format language; these individual documents must then be laboriously converted or indeed imported into programs provided for the purpose. With these known development platforms 1 to 5, EE architectures can be described and constructed within a vehicle with respect to a specific function, and a number of development platforms are necessary in each case for the presentation of the overall architecture. It is therefore time-consuming and complicated in the case of complex technical systems, to recreate the various interactions of the individual architectures with one another, if for example a component is relocated into a new installation space or indeed features and the function of a component are reduced or increased.

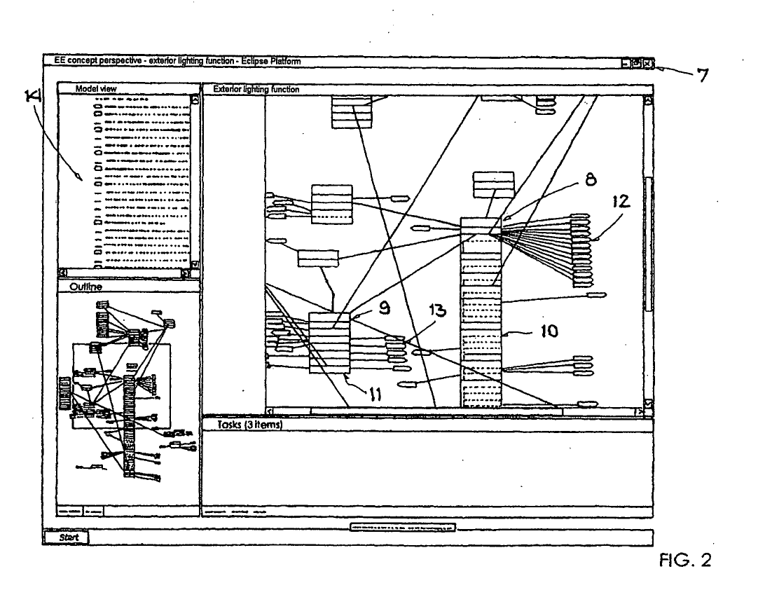

FIG. 2 shows a user interface 7 for the method according to the invention. This figure concerns a model-based input of the individual electronic architecture components 8, 9 with the respectively relevant descriptive functions 10 and 11, and the various interfaces with respect to further components 12 and 13. This user interface 7 represents a first development environment for the presentation of an overall architecture in accordance with a first development environment in a means of transport. The user interface 7 can be used for example to establish, based on a list of features 14, for each component or subassembly 8, 9, which features 14 are assigned to the respective component 8 or 9.

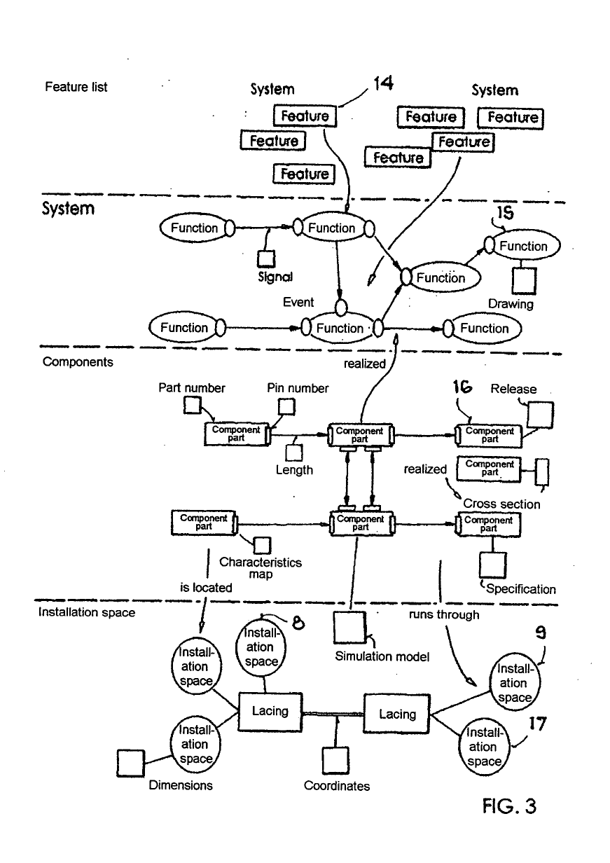

As represented in FIG. 3, the list of features 14 or feature list can be built up progressively for each component of the overall architecture model. In a further step, each component is assigned the various functions it has to carry out. The functions 15 indicate (for a control device, for example) that it is possible for a light to be switched on and a light to be switched off.

By contrast, a feature 14 for the component describes for example the power requirements with respect to the electrical power supply, the intensity of the light, the type of lamp necessary for this, etc. When the features and the function for each subassembly (i.e., for the engine control system, for the vehicle stability systems such as ABS, ESP, traction control and so on, and also for the electronic comfort components in the interior compartment of the vehicle) have been specified, the electrical configuration of the components is described by means of circuit diagrams at 16. Details of the electronic components are given in these diagrams, with the type and the wiring being modeled, so that a modeling specific to each particular component part is obtained.

Finally, each component part is assigned the installation space 17 provided in the means of transport. This means that, along with the list of features 14, the functional description 15 and the actual configuration of the electronic components 16, there is an exact assignment of the installation space for the components 8 and 9 in the vehicle. This description is then stored by means of a technical descriptive language such as XML, UML or HTML, and used for the calculations of the development system.

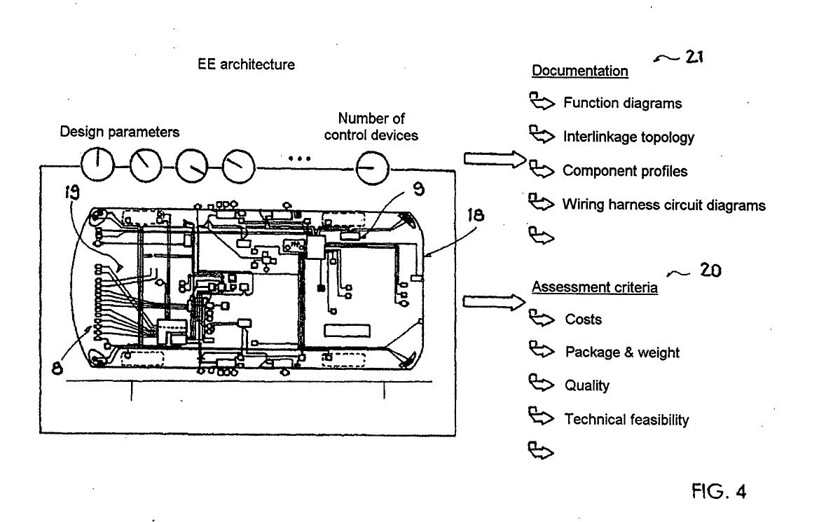

As represented in FIG. 4, the individual component parts 8, 9 are superimposed on an outline 18 of the vehicle in a manner corresponding to the respective installation spaces. For this purpose, the electrical connection 19 between the individual components is also determined and wired according to requirements, by means of specific design parameters. For this purpose, the method takes into account the predetermined number of control devices and assessment criteria 20, with costs, the packages and weight of the individual component parts and a technical feasibility test being provided. In addition to the technical development method, the entire development phase can be documented by the development system according to the invention at 21 by means of function diagrams, an interlinkage topology, component profiles and wiring harness circuit diagrams.

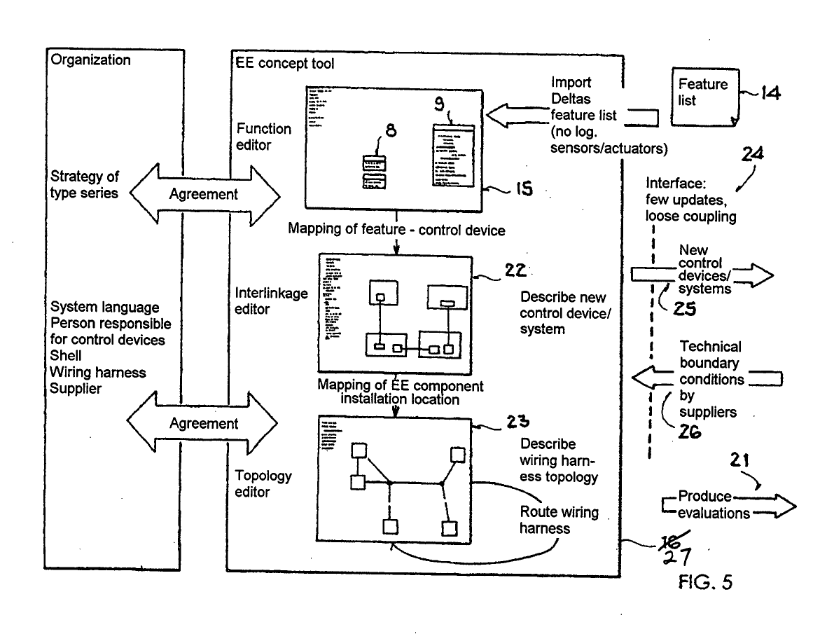

FIG. 5 shows the individual method steps according to the invention for production of the complex technical system in the vehicle. In this case, the overall system may represent the complete vehicle in its specific electrical/electronic form, or indeed only parts thereof (for example, an engine control system). First, the user interface 7 (FIG. 2) is used to establish a strategy in which necessary features and functions of the overall EE architecture that have to be developed are established for a type series. For example, the system language is established; this includes either the meta language, with which the model is technically described, or the programming language, in which the programs capable of running on the control devices are to be created. The mechanical and technical dimension-related requirements for the shell of the vehicle are taken over from the CAD system and taken into account in the method according to the invention. Finally, features and functions of the wiring harness are also established and the supplier is also assigned to each subassembly, so that interfaces in the overall architecture model can be provided, in order later to pass on the development submodel with the interfaces predetermined by the method to the individual suppliers. As a result, they are able to produce the developed EE architecture system, which can then be fitted later into the overall EE architecture system of the vehicle on the basis of the exactly defined interfaces.

The development system 27 according to the invention (FIG. 5) has, along with the function editor 15 (in which the functions can be assigned to the individual subassemblies), an interlinkage editor 22 in which the interlinkage between the individual components is implemented, and a topology editor 23 in which the wiring harness is routed in accordance with the assignment of the individual components and subassemblies to the installation spaces. (That is, it is optimized with respect to length and laying in the installation spaces.) The line router is a 3D router, which can calculate the optimum line laying taking into account the dimensioning of the vehicle body shell.

The method according to the invention also provides interfaces 24, via which changes in the overall architecture model can be introduced, such as for example the subsequent introduction of new control devices at 25 or taking over of the information with respect to the features and functions of individual components at the premises of the subcontracted supplier 26. The method evaluates the various data in accordance with the predetermined functions and features or the predetermined components, and documentation information 21 is generated and lists of features 14 can subsequently be newly read in and changed.

One advantage of the present system or the present method is that an overall EE architecture model is modeled and implemented completely throughout in accordance with the features and functions and also topologies. In addition, when there are changes in the development process, the various dependencies are defined and described with the aid of mathematical and physical functions, so that, when two components are combined to form a single unit, the interlinkage interfaces and the necessary interlinkage are automatically calculated and each developer is presented at every point in time with the requirements for his subassemblies that are to be developed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a complex technical system in a vehicle, comprising:
defining technical component states for each component in the system;
based on the defined component states, producing an overall model of the system in which all states for all components are stored;
for each component, establishing electrical component parts thereof, and assigning an installation space within the vehicle, producing an overall electronic architecture model for the vehicle, with each component being allocated specific electrical component parts, an installation space and component states; and
establishing electrical cabling of the electrical component parts of the components and their interfaces; wherein,
when a component is relocated into a different installation space of the vehicle or when a range of possible component states of a component is changed, necessary signal transmitting operations between the components are calculated for the overall architecture model.

2. A method for producing a complex technical system in a vehicle comprising:
defining technical component states for each component in the system;
based on the defined component states, producing an overall model of the system in which all states for all components are stored;
for each component, establishing electrical component parts thereof, and assigning an installation space within the vehicle, with the overall model, the installation spaces and the electronic component parts producing an overall electronic architecture model for the vehicle wherein each component is allocated specific electrical/electronic component parts, an installation space and their component states;
establishing electrical cabling of the individual component parts of the components and their interfaces; and
displaying the overall architecture model on an outline depiction of the vehicle; wherein
when a component is relocated to a different installation space of the vehicle or when a range of possible component states of a component is changed, necessary changes with respect to the architectural arrangement of the electronic component parts are calculated or optimized for the overall architecture model.

3. The method as claimed in claim 1, wherein:
one of the components is exterior lighting of the vehicle;
positioning of the light sources in the outline of the vehicle, positioning of the associated electrical components and control devices, and cabling/interlinkage of the component parts are calculated in the overall architecture model; and
the interlinkage is optimized with respect to at least one of electrical and information technology signals.

4. The method as claimed in claim 2, wherein:
one of the components is exterior lighting of the vehicle;
positioning of the light sources in the outline of the vehicle, positioning of the associated electrical components and control devices, and cabling/interlinkage of the component parts are calculated in the overall architecture model; and
the interlinkage is optimized with respect to at least one of electrical and information technology signals.

5. The method as claimed in claim 1, further comprising:
providing a threshold value for a number of signals to be transmitted for each transmission medium of the cabling; and
calculating signals resulting from the electronic architecture at the time; wherein,
if the threshold value is exceeded, one of the following is executed—producing a further transmission medium, calculating an alternative signal path, and generating an error message.

6. The method as claimed in claim 2, further comprising:
providing a threshold value for a number of signals to be transmitted for each transmission medium of the cabling; and
calculating signals resulting from the electronic architecture at the time; wherein,
if the threshold value is exceeded, one of the following is executed—producing a further transmission medium, calculating an alternative signal path, and generating an error message.

7. The method as claimed in claim 3, further comprising:
providing a threshold value for a number of signals to be transmitted for each transmission medium of the cabling; and
calculating signals resulting from the electronic architecture at the time; wherein,
if the threshold value is exceeded, one of the following is executed—producing a further transmission medium, calculating an alternative signal path, and generating an error message.
